(19) United States
(12) Patent Application Publication
(10) Pub. No.: US 2026/0290215 A1
(43) Pub. Date: Sep. 24, 2026

(54) Autostereoscopic Display Apparatus

(71) Applicant: JoyVision Technology.,CO LTD, Taoyuan City (TW)

(72) Inventors: Cheng-Chung Hu, Taoyuan City (TW); Han-Hsun Kuo, Taoyuan City (TW)

(21) Appl. No.: 19/696,487

(22) Filed: Jun. 3, 2026

Related U.S. Application Data
(63) Continuation-in-part of application No. 19/241,571, filed on Jun. 18, 2025, now Pat. No. 12,676,092.
Application No. 19/241,571 is a continuation-in-part of application No. 19/068,197, filed on Mar. 3, 2025, now Pat. No. 12,366,765.

(30) Foreign Application Priority Data
Nov. 6, 2024 (TW) 113142612

(51) Int. Cl. G09G 3/00; H04N 13/111; H04N 13/305; H04N 13/398

(52) U.S. Cl. CPC G09G 3/003; H04N 13/111; H04N 13/305; H04N 13/398; G09G 2320/0209; G09G 2320/0686

(57) ABSTRACT

An autostereoscopic display apparatus includes a display pixel array configured to generate image content. For a given display pixel, a processor determines a spatial relationship between the display pixel and a boundary separating adjacent viewpoint images and determines a luminance value according to a nonlinear luminance transition function. A local slope of the nonlinear luminance transition function may vary according to the spatial relationship to reduce crosstalk while maintaining image brightness. In some embodiments, luminance behavior may be adaptively adjusted according to display regions, image characteristics, or operating conditions.

### CROSS-REFERENCE TO RELATED APPLICATIONS

This application is a continuation-in-part of U.S. patent application Ser. No. 19/241,571, filed on Jun. 18, 2025, the disclosure of which is incorporated herein by reference in its entirety.

### PRIOR ART

Autostereoscopic displays utilizing lenticular lenses are designed to direct light from different image portions toward different viewing zones, thereby delivering different images to a viewer's left and right eyes without requiring eyewear. Ideally, light associated with each viewpoint image is accurately directed toward its intended viewing zone. In practice, however, light leakage may occur near boundaries between adjacent viewing zones. Such leakage may cause image information intended for one eye to be perceived by the other eye, resulting in crosstalk and visual artifacts such as ghost images. To reduce such crosstalk, various techniques have been proposed in which luminance of pixels located near lenticular pitch boundaries or viewing-zone boundaries is reduced or selectively suppressed. For example, some approaches reduce or deactivate pixels located near boundary regions in an attempt to reduce leakage between adjacent viewpoint images. Although such approaches may improve crosstalk performance, excessive luminance reduction may undesirably reduce overall display brightness. In addition, a viewer may perceive visible dark patterns, grid-like artifacts, or screen-door effects during stereoscopic viewing, thereby degrading perceived image quality.

In addition, under ideal conditions, optical elements in an autostereoscopic display are expected to exhibit substantially uniform shapes and dimensions. In practical implementations, however, manufacturing tolerances, assembly variations, and process-related imperfections may cause deviations among optical elements. For example, deformation introduced during molding processes, non-uniformities in optical structures, or irregular arrangements of light-emitting elements (e.g., LEDs or display pixels) may introduce spatial variations in optical characteristics across the display. Under such non-ideal conditions, optical behavior may vary across different display regions, resulting in spatially varying levels of crosstalk and non-uniform display performance. Consequently, luminance optimization techniques designed under idealized assumptions may not provide consistent performance across the display area.

Accordingly, there remains a need for display techniques capable of applying region-dependent luminance optimization strategies in order to improve overall display quality and visual uniformity.

### BACKGROUND OF THE INVENTION

The present invention optimizes brightness dynamically, ensuring clearer, high-quality autostereoscopic displays while reducing crosstalk artifacts.

### SUMMARY OF THE INVENTION

It is an object of the present invention to provide a display apparatus to improve overall display quality and visual uniformity for autostereoscopic display. In one embodiment, an autostereoscopic display apparatus is provided. The display apparatus may include a display pixel array configured to generate image content for viewing by a viewer, an array of optical elements disposed over the display pixel array, a memory storing computer-executable instructions, and a processor configured to execute the instructions. The optical elements may be configured to direct different viewpoint images toward a left eye and a right eye of the viewer so as to provide an autostereoscopic viewing effect without requiring specialized eyewear.

In some embodiments, for a given display pixel, the processor may determine a spatial relationship between the display pixel and a boundary separating adjacent viewpoint images. Based on the spatial relationship, the processor may determine a luminance value according to a nonlinear luminance transition function. In some embodiments, pixels located closer to the boundary may be assigned lower luminance values than pixels located farther from the boundary. Such luminance distribution may reduce optical leakage and crosstalk artifacts associated with adjacent viewpoint images. In some embodiments, the nonlinear luminance transition function may include spatially varying transition characteristics. For example, a local slope associated with the nonlinear luminance transition function may vary according to the spatial relationship. Accordingly, different ranges of spatial relationships may exhibit different luminance transition behaviors. Regions exhibiting relatively higher crosstalk may employ relatively steeper luminance transitions, whereas regions exhibiting relatively lower crosstalk may employ relatively smoother luminance transitions.

Through such spatially adaptive luminance adjustment, crosstalk may be reduced while preserving image brightness and improving perceived stereoscopic image quality. In various embodiments, the nonlinear luminance transition function may further include one or more adaptive parameters, region-specific parameters, or dynamically adjustable control coefficients to support different display conditions and optical characteristics.

In some embodiments, the nonlinear luminance transition function may include one or more local slope characteristics associated with different portions of the function. The local slope may describe a rate of luminance variation with respect to a spatial relationship associated with a display pixel. For example, a first range of spatial relationships may exhibit a first local slope, while a second range of spatial relationships may exhibit a different local slope. Accordingly, luminance transition behavior may vary across different portions of the nonlinear luminance transition function rather than remaining constant throughout the function. In some embodiments, relatively larger local slopes may be employed near boundary regions so as to provide more rapid luminance attenuation in regions exhibiting relatively high crosstalk, whereas relatively smaller local slopes may be employed in regions farther from boundaries so as to preserve luminance uniformity.

One or more local slope characteristics may be controlled according to one or more parameters associated with the nonlinear luminance transition function, including control coefficients, slope parameters, transition parameters, or combinations thereof. In some embodiments, local slope characteristics may be dynamically adjusted according to image-content characteristics, viewing conditions, region information, or operating conditions. Accordingly, different ranges of spatial relationships may exhibit different luminance transition rates and different transition profiles.

Through dynamic luminance adjustment based on spatial relationships between pixels and viewpoint-image boundaries, crosstalk may be reduced while improving perceived stereoscopic image quality and display performance. These and other features and advantages of the present disclosure will become apparent from the following detailed description and accompanying drawings.

### BRIEF DESCRIPTION OF DRAWINGS

FIGS. 1A-1B illustrate a conventional autostereoscopic display.

FIGS. 2A-2B provide schematic plan views of a typical autostereoscopic display.

FIG. 3 illustrates an embodiment of the apparatus that determines optimized brightness based on the distance from a given pixel to the nearest boundary end.

FIGS. 4A-4B depict a liquid crystal lens that repeatedly forms groups of display pixels, separated by boundaries.

FIG. 5 illustrates another embodiment, where pixels located between a boundary and a set of central pixels are dimmed relative to the central pixels of each image.

FIGS. 6A-6E present another embodiment incorporating an equation for calculating the optimized brightness of any given pixel.

FIGS. 7A-7B illustrate another embodiment featuring a system that delivers separate images to a viewer's eyes, enabling autostereoscopic display.

FIG. 8 illustrates another embodiment in which a processor executes computer-readable instructions to provide an autostereoscopic display.

FIGS. 9A-9B present another embodiment utilizing an equation to determine the optimized brightness of any given pixel.

FIG. 10 illustrates another embodiment incorporating an alternative equation for calculating the optimized brightness.

FIGS. 11A-11B illustrate additional embodiments incorporating alternative equations for calculating the optimized brightness.

FIGS. 12A-12C illustrate further embodiments incorporating different equations for calculating the optimized brightness.

### DETAILED DESCRIPTION OF THE INVENTION

Various embodiments of the present disclosure will now be described with reference to the accompanying drawings. In the following detailed description, numerous specific details are set forth in order to provide a more complete understanding of the disclosed embodiments. However, one of ordinary skill in the art will appreciate that the present disclosure may be practiced without one or more of these specific details. In other instances, well-known structures, components, methods, and processing techniques are not described in detail so as not to unnecessarily obscure aspects of the present disclosure.

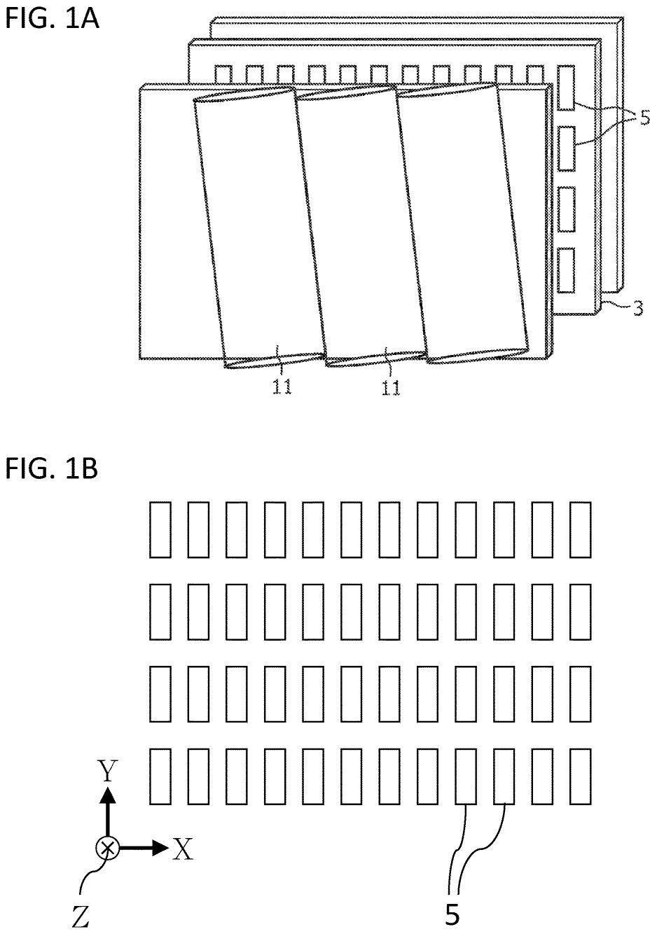

Referring to FIGS. 1A and 1B, an autostereoscopic display apparatus includes a display pixel array 3 including a plurality of display pixels 5 arranged in rows and columns. The display pixel array 3 extends along a row direction (X-axis) and a column direction (Y-axis). An array of elongated optical elements 11 is disposed in a Z-direction, which is substantially perpendicular to the X-direction and the Y-direction. The optical elements 11 are arranged substantially parallel to one another and are positioned over the display pixel array 3. In some embodiments, the optical elements 11 may comprise lenticular lenses, liquid-crystal lenses, or other optical directing structures configured to guide light toward different viewing zones.

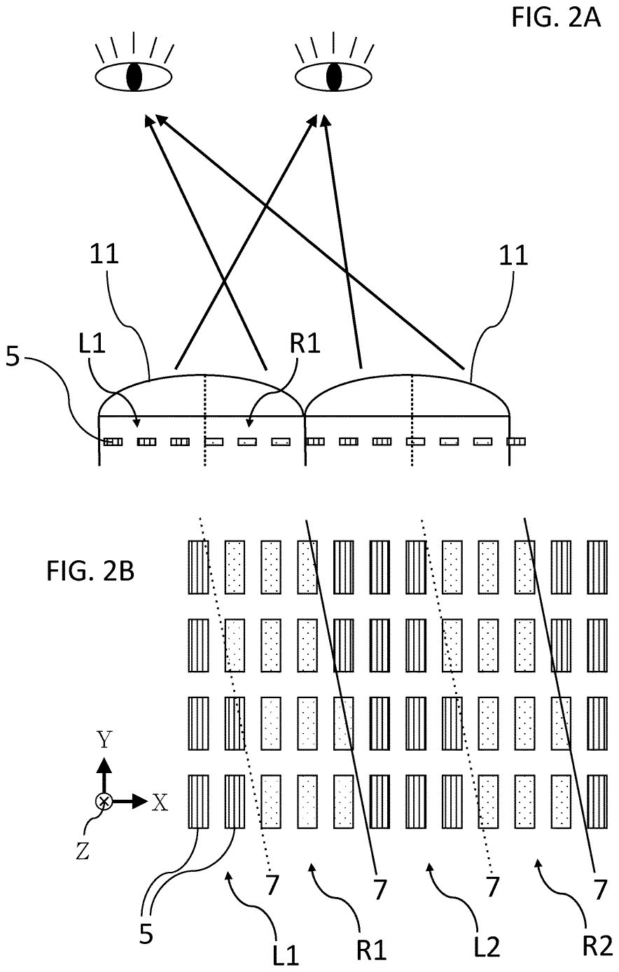

Referring further to FIGS. 2A and 2B, the display pixels 5 may be viewed through the optical elements 11. The optical elements 11 are configured to direct different viewpoint images toward corresponding eyes of a viewer so as to provide an autostereoscopic three-dimensional viewing effect. For example, different pixel sets, such as R1, R2, L1, and L2, may be directed toward respective eyes of the viewer by the optical elements 11. In some embodiments, pixel sets corresponding to right-eye images and left-eye images may be spatially interleaved across the display pixel array and optically separated by the optical elements 11 to form multiple viewpoint images. The optical elements 11 may be disposed at an inclined angle relative to the column direction (Y-axis) of the display pixel array so as to improve separation of visual information. Through the inclined arrangement, the optical elements 11 may repeatedly define a plurality of display pixel groups, such as pixel sets R1, R2, L1, and L2, each pixel set including adjacent display pixels 5. In some embodiments, the inclined optical arrangement may improve distribution of viewpoint images and reduce visual artifacts associated with image separation. Although illustrated embodiments employ inclined optical elements, other arrangements may also be used without departing from the scope of the present disclosure.

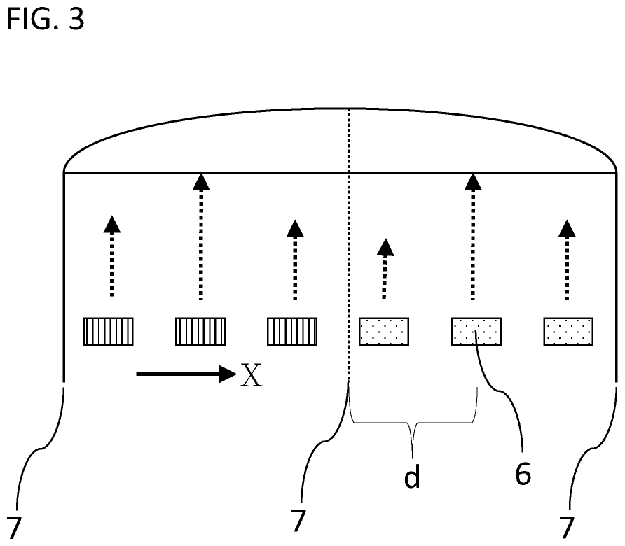

Referring to FIG. 3, for a given pixel 6 among the display pixels, an optimized luminance value may be determined according to a distance d between the given pixel 6 and a nearest portion of a boundary 7 separating adjacent viewpoint images along the row direction (X-axis). As illustrated in FIGS. 2A and 2B, adjacent viewpoint images may include multiple pixel sets, such as R1, L1, L2, and R2. The optical elements may direct light associated with the pixel sets toward respective eyes of a viewer such that different viewpoint images are perceived by the viewer, thereby providing an autostereoscopic viewing effect.

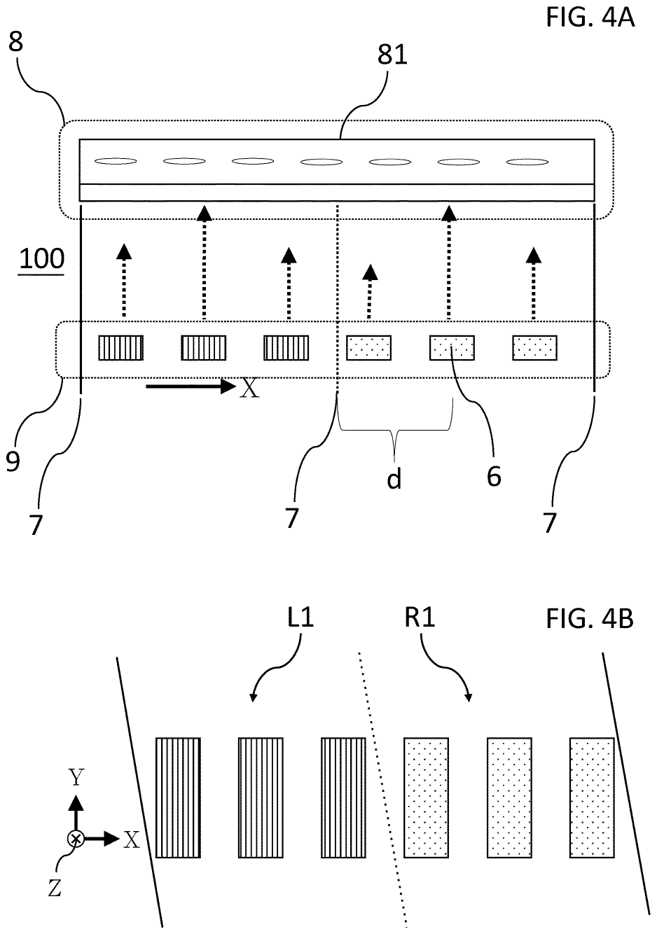

In another embodiment, referring to FIGS. 4A and 4B, the optical elements may comprise liquid-crystal lenses 8. A display apparatus 100 may include a display panel 9 configured to generate image content and including a display surface extending along a row direction X and a column direction Y, wherein the row direction X and the column direction Y are substantially perpendicular to each other. The liquid-crystal lenses 8 may be disposed above the display panel 9 and may include a plurality of lens units 81. Each lens unit 81 may extend along a third direction intersecting the column direction Y. The plurality of lens units 81 may repeatedly define display pixel groups, such as pixel sets R1 and L1, separated by boundaries 7 between adjacent viewpoint images. In some embodiments, the lens units 81 may function as optical directing structures configured to direct different viewpoint images toward different eyes of a viewer to provide an autostereoscopic effect.

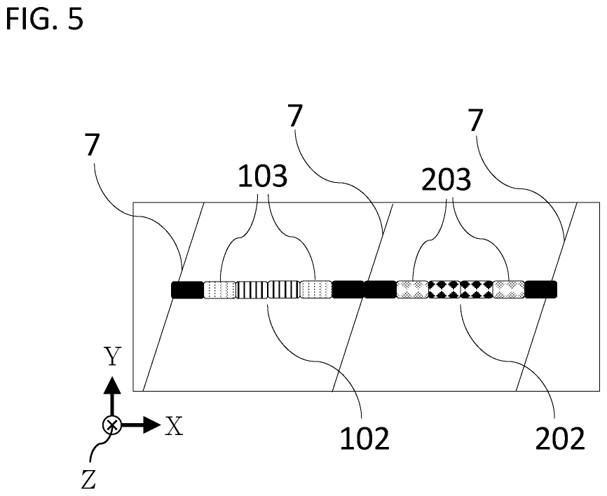

In one embodiment, referring to FIG. 5, luminance values of display pixels may progressively increase along the row direction X. Center pixels 102 and 202 associated with respective viewpoint images may experience relatively lower levels of crosstalk and therefore may be assigned higher luminance values. Beginning from pixels located near a boundary 7, luminance values may gradually increase toward pixels located closer to central regions of viewpoint images. For example, pixels 103 and 203 located between the boundary 7 and corresponding center pixels 102 and 202 may be assigned luminance values lower than those of the center pixels 102 and 202. Accordingly, luminance values may progressively increase as a function of increasing distance from the boundary. Pixels located between a boundary and a corresponding center region of a viewpoint image may be assigned luminance values lower than those of center pixels associated with the viewpoint image.

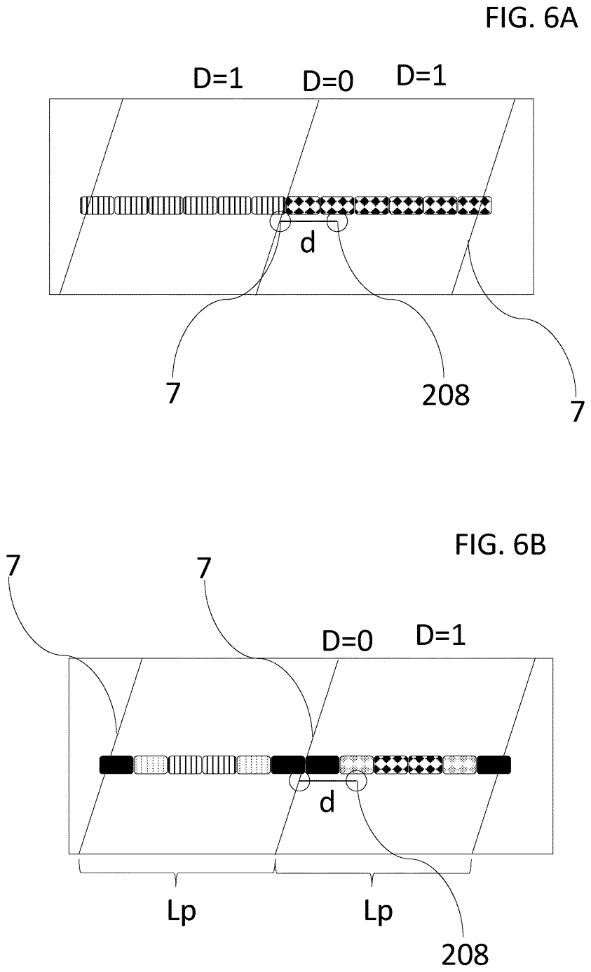

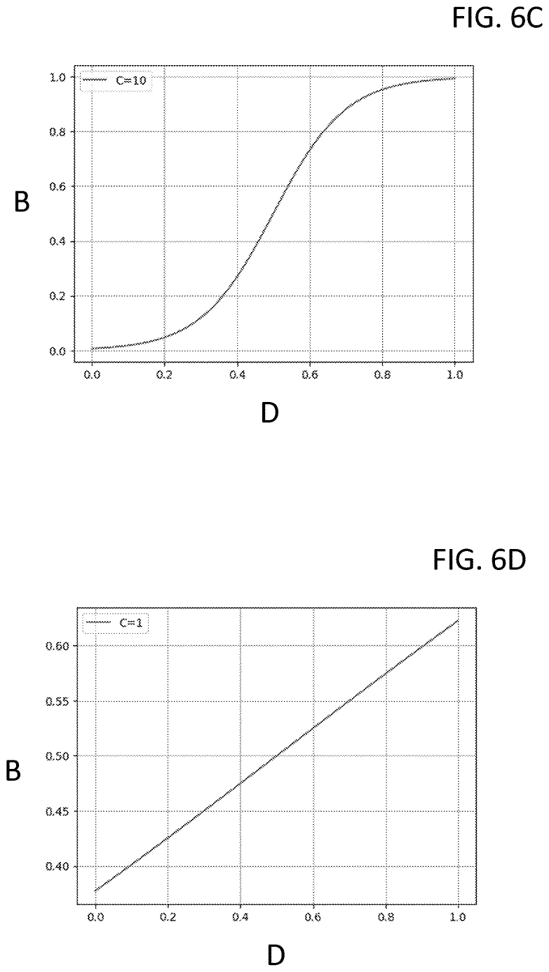

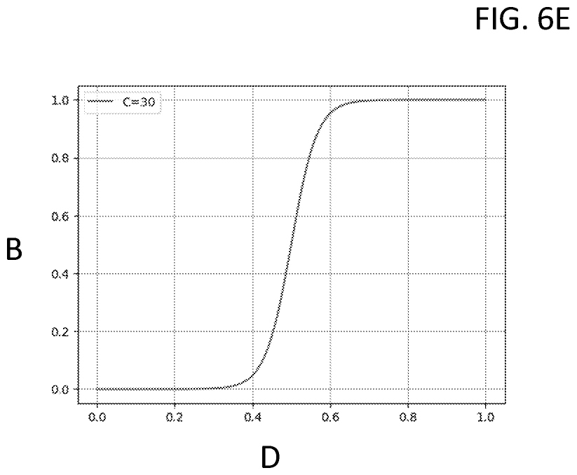

In another embodiment, referring to FIG. 6A, a mathematical mapping function may be employed to determine luminance values of display pixels. For a given pixel, such as pixel 208, a distance between the given pixel and a nearest boundary 7 separating adjacent viewpoint images may be determined. The determined distance may be converted into an input parameter D and provided to the mapping function to determine an appropriate luminance value. Since center pixels of viewpoint images generally experience reduced crosstalk, the mapping function may be configured such that an output value increases as D increases. In some embodiments, the output value may approach a maximum value when D approaches 1. In one embodiment, an optimized luminance ratio B may be determined according to: B=1/(1+e\hat{ }(−C×(D−0.5))), where: C represents a control coefficient greater than zero; D represents a normalized distance corresponding to a ratio between a distance from the given pixel to a nearest boundary and a pitch Lp of an optical element; and B represents a ratio between an optimized luminance value and a maximum luminance value associated with the given pixel.

Referring to FIG. 6B, the pitch Lp may correspond to a spacing between adjacent boundaries 7 that separate adjacent viewpoint images formed by different pixel sets. Different control coefficients C may be selected according to characteristics of the optical elements or desired crosstalk reduction performance. In some embodiments, relatively larger values of C may produce steeper luminance transitions. For example, in one embodiment C may be greater than 10, such that the function output approaches 1 as D approaches 1, as illustrated in FIG. 6C. In other embodiments, different values of C may be employed. For example, C may be set to 1, as illustrated in FIG. 6D, or may be set to 30, as illustrated in FIG. 6E. By adjusting the control coefficient C, luminance values may be adaptively controlled according to spatial relationships between pixels and boundaries. For a given pixel, the distance from the pixel to a boundary region may be determined and used as an input parameter D for determining an associated luminance value.

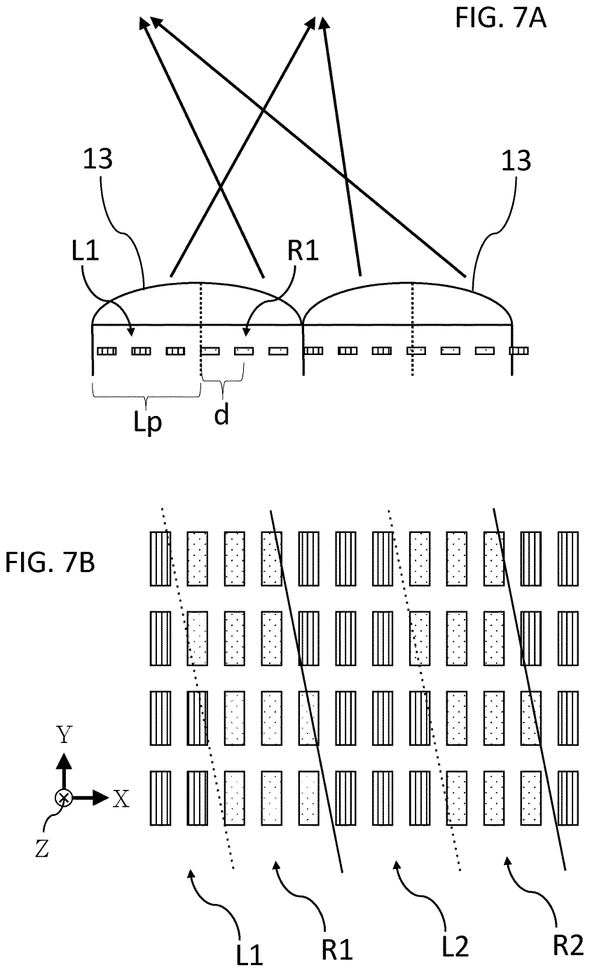

In one embodiment, referring to FIGS. 7A and 7B, a system configured to provide different viewpoint images to respective eyes of a viewer for autostereoscopic viewing is provided. The viewpoint images may include, for example, pixel sets L1, R1, L2, and R2. The system may include an autostereoscopic display apparatus having a display pixel array including display pixels arranged in rows and columns, and an array of elongated lenticular elements 13 disposed above the display pixel array. The display pixels may be viewed through the lenticular elements 13. The lenticular elements 13 may function as optical directing structures configured to direct different viewpoint images toward corresponding eyes of a viewer, thereby providing an autostereoscopic three-dimensional viewing effect without requiring specialized eyewear.

In some embodiments, the lenticular elements 13 may have a pitch Lp measured along the row direction X, wherein the pitch Lp is greater than a distance d between a display pixel and a nearest portion of a boundary separating adjacent viewpoint images. Based on the foregoing structure, an optimized luminance ratio B may be determined according to a luminance mapping function. In one embodiment, the luminance ratio B may be determined according to: B=1/(1+e\hat{ }(−C×(D−0.5))), where: C represents a coefficient greater than zero; D represents a normalized distance corresponding to a ratio between the distance d and the optical-element pitch Lp; and B represents a ratio between an optimized luminance value and a maximum luminance value associated with a given display pixel.

In some embodiments, the pitch Lp may correspond to a spacing between adjacent boundaries separating viewpoint images formed from different pixel sets. Accordingly, the autostereoscopic display system may employ a display pixel array and an array of elongated optical elements to direct different viewpoint images toward respective eyes of a viewer. By adjusting luminance according to a luminance mapping function associated with spatial relationships between pixels and viewpoint-image boundaries, crosstalk may be reduced while preserving image quality.

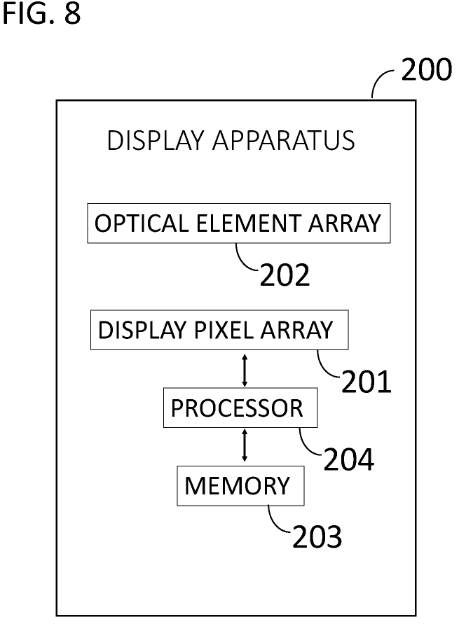

Referring to FIG. 8, in another embodiment, a display apparatus may include a display pixel array having display pixels arranged in rows and columns, an array of elongated optical elements disposed above the display pixel array and extending substantially parallel to one another, a memory storing computer-readable instructions, and a processor configured to execute the computer-readable instructions. The processor may be configured to determine a distance between a given display pixel and a nearest portion of a boundary separating adjacent viewpoint images. The adjacent viewpoint images may include multiple pixel sets, and the optical elements may direct light associated with the pixel sets toward respective eyes of a viewer to provide an autostereoscopic viewing effect. The processor may further determine an optimized luminance value of the given display pixel according to a luminance mapping function. In one embodiment, an optimized luminance ratio B may be determined according to: B=1/(1+e\hat{ }(−C×(D−0.5))), where: C represents a coefficient greater than zero; D represents a ratio between the determined distance and a pitch of the optical elements; and B represents a ratio between an optimized luminance value and a maximum luminance value associated with the given display pixel.

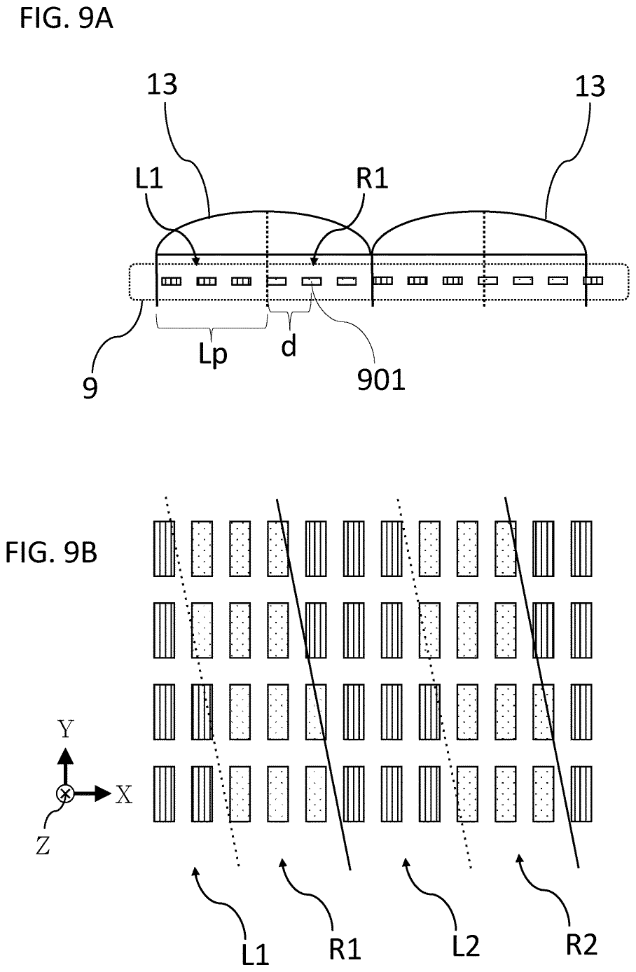

In another embodiment, referring to FIGS. 9A and 9B, a method for determining an optimized luminance value of a given pixel 901 for controlling three-dimensional image output is provided. The method may be implemented in a display apparatus including a display pixel array 9 arranged in rows and columns and an array of elongated optical elements disposed above the display pixel array and extending substantially parallel to one another. The method may include determining a distance d between the given pixel and a nearest portion of a boundary separating adjacent viewpoint images. The adjacent viewpoint images may include multiple pixel sets, and the optical elements may direct light associated with the pixel sets toward respective eyes of a viewer such that different viewpoint images are perceived by the viewer, thereby providing an autostereoscopic viewing effect. In some embodiments, the method may further include determining an optimized luminance value according to a luminance mapping function based on the distance d or a parameter derived therefrom.

The method may determine an optimized luminance value according to: B=1/(1+e\hat{ }(−C×(D−0.5))), where: C represents a coefficient greater than zero; D represents a ratio between the distance d and an optical-element pitch Lp; and B represents a ratio between an optimized luminance value and a maximum luminance value associated with a given display pixel. Thus, the disclosed display apparatus may determine luminance values according to spatial relationships between display pixels and boundaries separating adjacent viewpoint images. In some embodiments, the processor may determine a distance d between a given pixel and a nearest portion of a boundary, determine a luminance ratio B according to a luminance mapping function, and adjust a luminance value of the pixel according to the determined luminance ratio so as to reduce crosstalk and improve perceived three-dimensional image quality.

In another embodiment, referring to FIGS. 8, 9A, and 9B, an autostereoscopic display apparatus 200 is provided. The display apparatus 200 may include a display pixel array 201 configured to generate image content for viewing by a viewer, an optical-element array 202 disposed above the display pixel array 201, a memory 203 storing instructions, and a processor 204 configured to execute the instructions. The optical-element array 202 may include elongated optical elements extending substantially parallel to one another. The optical elements may be configured to direct different viewpoint images, such as pixel sets L1, R1, L2, and R2, toward a left eye and a right eye of a viewer to provide an autostereoscopic effect.

For a given display pixel 901, the processor 204 may determine a distance d between the display pixel 901 and a nearest portion of a boundary separating adjacent viewpoint images. The processor 204 may further determine a distance ratio D according to: D=d/Lp, where Lp represents a pitch of the optical elements. In some embodiments, as illustrated in FIG. 9A, the pitch Lp may be greater than the distance d measured along the row direction. The processor 204 may further determine an optimized luminance ratio B according to a monotonically increasing S-shaped function. In some embodiments, the S-shaped function may be continuously differentiable and may include an inflection point. The function may be configured such that B approaches 0 as D approaches 0 and B approaches 1 as D approaches 1. In some embodiments, the inflection point may be located at or near: D=0.5. Through such luminance adjustment, luminance transition rates may vary across different spatial relationships, thereby reducing crosstalk while preserving image brightness and improving stereoscopic image quality.

By employing the foregoing S-shaped luminance adjustment function, pixels located in central regions of viewpoint images may be assigned relatively higher luminance values, while pixels located near boundaries between adjacent viewpoint images may be assigned relatively lower luminance values. Such luminance distribution may reduce crosstalk artifacts associated with stereoscopic display and may improve image clarity and perceived three-dimensional viewing quality. In some embodiments, the S-shaped function may be implemented using different mathematical models. For example, the S-shaped function may comprise a sigmoid function, a hyperbolic tangent (tanh) function, an error (erf) function, an arctangent (arctan) function, a generalized logistic function, a Gudermannian function, or other functions exhibiting S-shaped characteristics and one or more inflection regions.

Parameters associated with the foregoing functions may be adjusted according to application requirements. In some embodiments, one or more control parameters may be configured to adjust characteristics of the luminance transition, including transition slope, curvature, transition rate, or combinations thereof. In some embodiments, such parameters may be dynamically selected according to image-content characteristics, local contrast, viewing conditions, display regions, or other operating conditions. Accordingly, embodiments of the present disclosure may be applied to various autostereoscopic display systems, including but not limited to display panels employing lenticular lenses, light-field display systems, switchable lens arrays, liquid-crystal lens structures, and other optical directing arrangements. The disclosed techniques are not limited to particular display-panel technologies, optical structures, or lens-manufacturing processes. Various modifications and alternative implementations may be employed without departing from the scope of the present disclosure.

In some embodiments, the S-shaped function may comprise a sigmoid function represented as: B=1/(1+e\hat{ }(−C×(D−0.5))), where C represents a positive control coefficient configured to control steepness of the transition curve. As C increases, the luminance transition region may become narrower, thereby providing sharper luminance transitions that may be suitable for applications requiring stronger viewpoint separation.

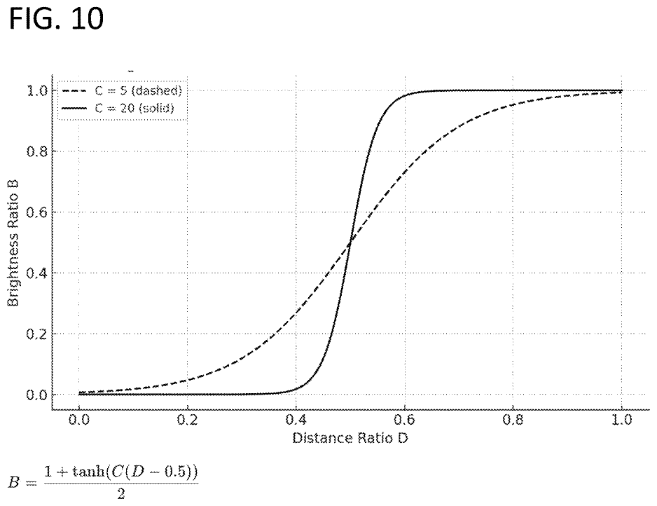

In other embodiments, referring to FIG. 10, the luminance function may comprise a hyperbolic tangent (tanh) function represented as: B=(1+tanh(C×(D−0.5)))/2. The foregoing function may also be continuously differentiable and monotonically increasing, and may exhibit S-shaped characteristics similar to those of a sigmoid function. Steepness near an inflection region may likewise be adjusted through control parameter C.

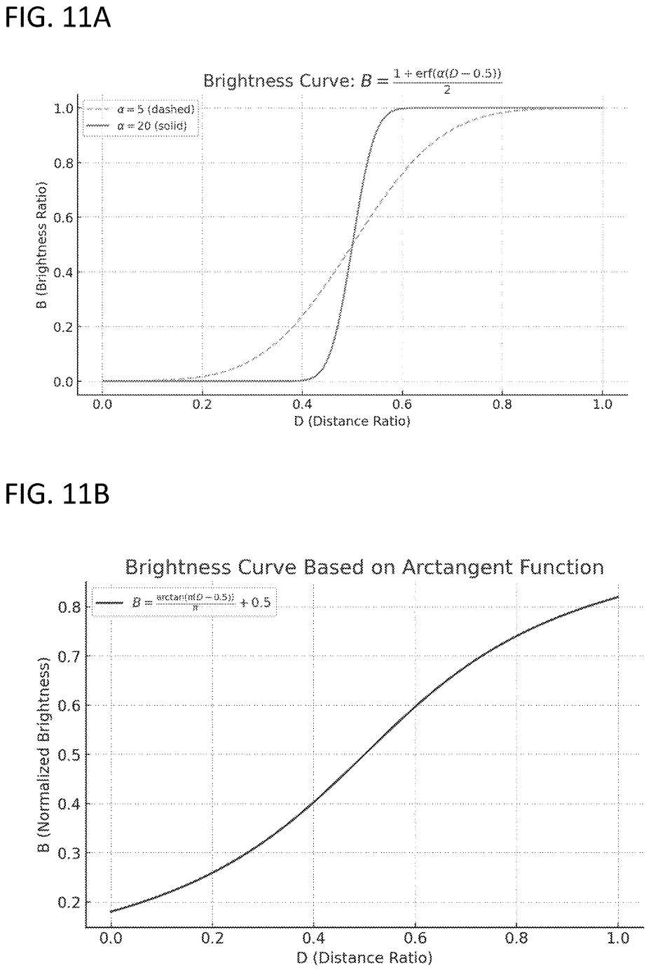

In further embodiments, referring to FIG. 11A, the luminance function may additionally comprise an error (erf) function or an arctangent (arctan) function. For example: B=(1+erf(α×(D−0.5)))/2, where α represents a positive control coefficient. In illustrated examples, a relatively smaller α value may produce smoother luminance transitions, whereas larger values of α may generate steeper luminance changes near boundary regions. Larger values of α may cause transition behavior near inflection regions to become more concentrated, thereby facilitating more rapid luminance attenuation near image boundaries and reducing crosstalk artifacts.

Referring to FIG. 11B, the luminance function may alternatively be represented as: B=(arctan(π×(D−0.5))/π)+0.5. The foregoing functions may be continuously differentiable and may include one or more inflection regions exhibiting S-shaped characteristics. By employing such functions, smooth luminance transitions may be generated between pixels, thereby reducing visual artifacts associated with image boundaries. In further embodiments, the luminance function may comprise a Gudermannian function represented as: B=(2/π)×arctan(tanh(C×(D−0.5)/2))+½, where C represents a positive control coefficient configured to control steepness of the transition curve. Larger values of C may result in more concentrated transition behavior near inflection regions and may provide more rapid luminance attenuation near image boundaries, thereby reducing crosstalk.

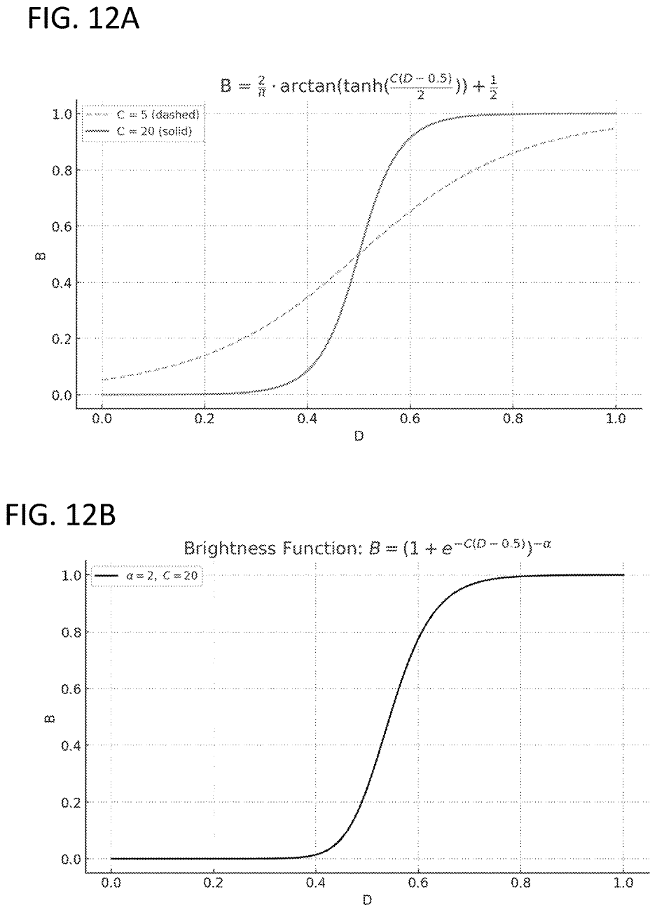

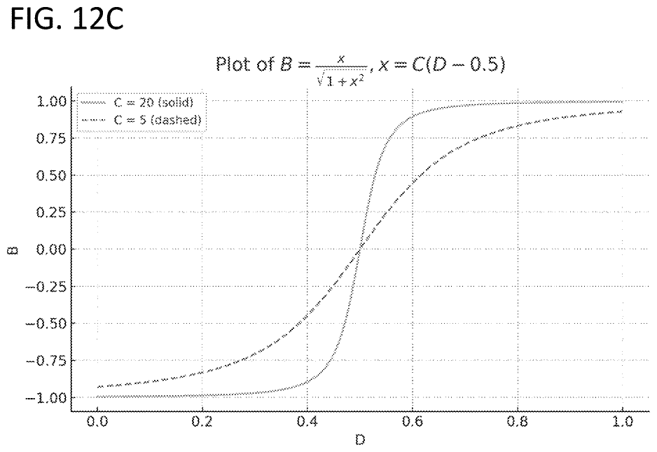

In other embodiments, referring to FIG. 12B, the luminance function may comprise a generalized logistic function represented as: B=(1+e\hat{ }{−C×(D−0.5)})\hat{ }{−α}, where α and C are positive constants configured to adjust characteristics of the transition curve. Larger values of α or C may increase transition steepness near inflection regions and may cause luminance transition rates to vary across a range of spatial relationships, thereby reducing crosstalk while preserving overall image brightness.

In further embodiments, the luminance function may additionally be represented according to: B=(x/sqrt(1+x\hat{ }2))/2, where x=C(D−0.5), and C represents a positive control coefficient configured to adjust transition characteristics of the luminance function. The foregoing function may exhibit continuously differentiable S-shaped characteristics and may include an inflection region. Larger values of C may increase transition steepness near the inflection region, thereby causing luminance transition rates to vary across different spatial relationships. Such luminance adjustment may reduce crosstalk while preserving overall image brightness and stereoscopic image quality.

Under ideal conditions, an autostereoscopic display apparatus may employ optical elements having substantially uniform shapes and dimensions. Referring to FIG. 9A, for a given display pixel 901, an optimized luminance value may be determined according to a distance d between the display pixel and a nearest portion of a boundary separating adjacent viewpoint images along the row direction (X-axis).

In practical implementations, however, optical elements may exhibit variations in shape, dimension, or other characteristics due to manufacturing tolerances, assembly variations, or process-related imperfections. For example, deformation introduced during molding processes, non-uniform optical structures, or irregular pixel arrangements may cause spatial variations across the display apparatus. Under such non-ideal conditions, the distance d and corresponding optical characteristics may vary among different display regions. Accordingly, the display may be partitioned into a plurality of regions.

In some embodiments, the regions may be defined according to spatial position, optical characteristics, calibration information, image-content characteristics, or combinations thereof. The regions may comprise regular or irregular shapes, and region size and quantity may be adjusted according to implementation requirements. For example, a region may correspond to a pixel block, a super-pixel region, or a dynamically generated segmentation result obtained through image analysis.

In some embodiments, granularity of the region partitioning may be adjustable according to computational-resource constraints, display requirements, image characteristics, or combinations thereof. In some embodiments, each region may be associated with one or more display control parameters. Such display control parameters may include, without limitation: luminance-adjustment parameters; crosstalk-compensation parameters; gamma-correction parameters; color-adjustment parameters; and three-dimensional enhancement parameters.

In some embodiments, the display control parameters may be determined according to calibration data, manufacturing variations of optical elements, spatial non-uniformity of the display apparatus, measured optical characteristics, or combinations thereof. In other embodiments, the display control parameters may be dynamically determined according to image features such as local contrast, color difference information, disparity information, edge characteristics, motion characteristics, or combinations thereof. For a given pixel, the processor may determine a spatial relationship between the pixel and a region associated with separation of viewpoint-image information. Such regions may include viewpoint boundaries, transition regions, or regions exhibiting elevated likelihoods of crosstalk.

In some embodiments, the spatial relationship may be represented using distance information, normalized coordinates, relative positions within a region, or other spatial descriptors capable of characterizing relationships between a pixel and viewpoint-image separation structures. After determining a region associated with the pixel, the processor may select or determine corresponding display control parameters according to the associated region.

In some embodiments, the display control parameters may be obtained from a lookup table stored in memory. In other embodiments, the display control parameters may be determined using mapping functions, mathematical models, machine-learning models, or combinations thereof. The display control parameters may be region-dependent, content-dependent, viewer-dependent, or dynamically updated during operation. The processor may further determine a luminance value according to a mapping function based on the spatial relationship and the display control parameters. The mapping function may define a relationship between spatial information and luminance values and may be implemented using mathematical functions, lookup tables, piecewise functions, interpolation methods, learning models, or combinations thereof.

In some embodiments, the mapping function may comprise continuous functions, monotonic functions, smooth functions, or combinations thereof so as to reduce visible artifacts. In some embodiments, the mapping function may be configured such that pixels associated with relatively higher crosstalk receive lower luminance values, whereas pixels associated with relatively lower crosstalk receive relatively higher luminance values. Crosstalk may arise from optical leakage, incomplete optical separation, geometric variations of optical elements, viewer-angle variations, or combinations thereof. Through luminance adjustment mechanisms based on region information and spatial relationships, crosstalk may be reduced while preserving overall brightness and perceived image quality.

In some embodiments, the mapping function and/or display control parameters may be adaptively adjusted according to operating conditions. For example, different mapping functions or parameter sets may be selected according to viewing distance, viewing angle, image content, disparity magnitude, user characteristics, or combinations thereof. In further embodiments, eye-position information and/or gaze-direction information obtained from an eye-tracking system may additionally be employed to optimize region partitioning and parameter selection.

In some embodiments, determination of display control parameters and luminance values may be performed in real time through hardware, software, firmware, or combinations thereof. For example, such operations may be implemented by a graphics processing unit (GPU), a timing controller (TCON), a display driver integrated circuit (DDIC), dedicated processing circuitry, or combinations thereof. In some embodiments, mapping functions and associated parameter sets may be precomputed, dynamically updated, generated through calibration procedures, or obtained through training processes.

Through the foregoing region-based and spatially adaptive luminance control mechanisms, crosstalk artifacts in autostereoscopic displays may be reduced while compensating for optical variations and manufacturing imperfections. Such techniques may additionally improve stereoscopic consistency among different display regions and enhance overall viewing quality. In one embodiment, a display apparatus is provided and may include a display pixel array, an optical-element array, a memory, and a processor. The display pixel array may include a plurality of display pixels arranged in rows and columns and configured to generate image content for viewing by a viewer. The optical-element array may be disposed above the display pixel array and may be configured to direct different viewpoint images toward respective eyes of a viewer to provide an autostereoscopic viewing effect. The optical elements may comprise lenticular lenses, liquid-crystal lenses, switchable optical structures, or other optical directing arrangements configured to provide viewpoint separation. Through such optical structures, different pixel sets may correspond to different viewpoint images and may be directed toward respective eyes of the viewer.

The processor may execute computer-executable instructions stored in the memory and may determine, for a given display pixel, a spatial relationship between the pixel and a boundary separating adjacent viewpoint images. Based on the spatial relationship, the processor may determine a luminance value according to a nonlinear luminance transition function. The nonlinear luminance transition function may be configured such that luminance values associated with pixels located near boundary regions are reduced, while pixels located farther from the boundary retain relatively higher luminance values.

Further, luminance transition rates may vary spatially so as to reduce crosstalk while preserving overall image brightness. In one embodiment, the spatial relationship may be represented by a distance ratio D according to: D=d/Lp, where d represents a distance between the given pixel and a boundary separating adjacent viewpoint images, and Lp represents a pitch of the optical elements. The distance ratio D may characterize a relative location of a pixel within a viewpoint image. As D increases from approximately 0 toward 1, the pixel location may transition from a boundary region toward a central region of the viewpoint image.

The processor may determine a luminance value according to the distance ratio D. In some embodiments, the nonlinear luminance transition function may comprise an S-shaped function. The S-shaped function may be continuously differentiable and may include one or more inflection regions such that luminance transitions exhibit relatively larger gradients near boundary regions and relatively smoother transitions away from boundaries.

In one preferred embodiment, an inflection region of the S-shaped function may be located at or near: D=0.5. Such an arrangement may cause luminance transitions to occur near intermediate regions of viewpoint images while preserving luminance levels in central regions and suppressing luminance near boundary regions.

In various embodiments, the S-shaped function may be selected from a group including: a sigmoid function; a hyperbolic tangent function; an error function; an arctangent function; a generalized logistic function; and a Gudermannian function.

In some embodiments, the processor may additionally be configured to dynamically select the nonlinear luminance transition function and/or associated parameters. Such selection may be based on one or more of: image-content characteristics, such as edge density, contrast, or depth information; viewing distance; disparity requirements; and image motion characteristics. For example, in dynamic-image scenarios, a function having relatively steeper transition behavior may be selected to improve response characteristics. Conversely, for static-image or text-display scenarios, a smoother transition function may be selected to improve visual stability.

In another embodiment, the nonlinear luminance transition function may include one or more control coefficients. In some embodiments, such control coefficients may be adaptively determined according to one or more of: local image contrast; edge characteristics; relative pixel position within an image region; or other image-content features. For example, in regions exhibiting relatively high-contrast boundaries, larger control coefficients may be employed to provide stronger luminance suppression near boundary regions. Conversely, in lower-contrast regions, smaller control coefficients may be employed to preserve luminance uniformity.

In another embodiment, the display pixel array may be partitioned into a plurality of regions. The regions may be defined according to image features, spatial locations, display modes, or combinations thereof. In such embodiments, the nonlinear luminance transition function and/or parameters associated therewith may be separately determined for different regions. For example, different regions may employ different function types, or alternatively may employ a common function having different control parameters.

Through region-based control, different luminance-adjustment behaviors may be implemented across display regions so as to further improve crosstalk reduction and display uniformity. In another embodiment, luminance values may be determined using a lookup table (LUT). In some embodiments, the lookup table may employ spatial relationships, such as distance ratio D, as an index and may store corresponding luminance values. During operation, the processor may determine a spatial relationship in real time and may access the lookup table to determine corresponding luminance values, thereby reducing computational complexity and improving processing efficiency. In various embodiments, the processor functionality disclosed herein may be implemented in one or more of: a timing controller (TCON); a graphics processing unit (GPU); display driver integrated circuitry (DDIC); dedicated image-processing circuitry; or combinations thereof.

In another embodiment, an autostereoscopic display apparatus is provided. The display apparatus may include a display pixel array arranged in rows and columns, and an array of elongated optical elements disposed over the display pixel array. The elongated optical elements may extend substantially parallel to one another and may be disposed at an inclined angle relative to a column direction of the display pixel array. For a given display pixel, an optimized luminance value may be determined based on a distance between the display pixel and a nearest portion of a boundary separating adjacent viewpoint images. In some embodiments, the adjacent viewpoint images may include multiple pixel sets, and the optical elements may direct light associated with the pixel sets toward different eyes of a viewer to provide an autostereoscopic effect. In some embodiments, the optical elements may comprise liquid-crystal lenses including a plurality of lens units. The lens units may repeatedly define groups of display pixels separated by boundaries between adjacent viewpoint images.

In some embodiments, luminance values of pixels may progressively increase with increasing distance from a boundary region. Thus, pixels located closer to a central region of a viewpoint image may exhibit reduced crosstalk and correspondingly higher luminance values. In another embodiment, a system configured to provide different images to a viewer's left and right eyes for autostereoscopic viewing is provided. The system may include an autostereoscopic display apparatus having a display pixel array arranged in rows and columns and an array of elongated lenticular elements disposed above the display pixel array. The lenticular elements may function as optical directing structures configured to direct different viewpoint images toward respective eyes of the viewer.

In some embodiments, a pitch of the elongated optical elements may be greater than a distance between a display pixel and a nearest portion of a boundary separating adjacent viewpoint images in a row direction. In some embodiments, the optical elements may comprise lenticular lenses, liquid-crystal lenses, or other optical directing structures extending along a third direction different from the row and column directions. Such optical structures may repeatedly define display pixel groups associated with adjacent viewpoint images.

In some embodiments, the display pixel array may be partitioned into a plurality of regions, and different regions may employ different luminance-adjustment behaviors. The regions may be defined according to spatial position, optical characteristics, image-content characteristics, calibration information, display modes, or combinations thereof. In some embodiments, region boundaries may be predetermined, dynamically generated, adaptively adjusted, or learned through training procedures. The regions may comprise regular geometric regions, irregular regions, overlapping regions, super-pixel regions, image-segmentation regions, or combinations thereof. Region size and granularity may be adjustable according to computational-resource limitations, display requirements, image complexity, or operating conditions.

In some embodiments, neighboring regions may partially overlap or may share one or more transition parameters. For a respective region, a nonlinear luminance transition function and/or one or more parameters associated therewith may be separately selected or determined. For example, different regions may employ: different function types; different slope parameters; different control coefficients; different inflection-point locations; different luminance transition rates; or combinations thereof.

In some embodiments, a first region may employ a first nonlinear luminance transition function, while a second region may employ a second nonlinear luminance transition function different from the first nonlinear luminance transition function. In other embodiments, multiple regions may employ a common nonlinear luminance transition function while using different parameter values. Region-dependent parameters may be obtained from lookup tables, calibration data, mathematical models, machine-learning models, or combinations thereof.

In some embodiments, region assignment and parameter selection may be dynamically updated during display operation according to image content, viewing conditions, viewer information, or operating conditions. Through region-dependent luminance control, spatial non-uniformity caused by optical variation, manufacturing tolerances, display nonuniformity, or crosstalk behavior may be compensated. In some embodiments, a region may correspond to an area exhibiting similar optical characteristics.

In some embodiments, the nonlinear luminance transition function may comprise an S-shaped function configured to provide smooth luminance transitions across different spatial relationships. Compared with functions exhibiting substantially constant transition rates or piecewise abrupt changes, S-shaped functions may provide gradual luminance variation while preserving continuity and reducing visible artifacts.

In some embodiments, luminance transitions near boundary regions may exhibit relatively larger local slopes, whereas transitions in regions farther from boundaries may exhibit relatively smaller local slopes. Such behavior may reduce abrupt luminance discontinuities and improve perceived image quality.

In some embodiments, the S-shaped function may be continuously differentiable. Continuous differentiability may reduce discontinuities associated with luminance transitions and may reduce visible artifacts, including brightness discontinuities, edge artifacts, or undesired visual patterns.

In some embodiments, the S-shaped function may include one or more inflection regions. An inflection region may correspond to a location at which transition behavior changes from a relatively increasing transition rate to a relatively decreasing transition rate.

In some embodiments, local slope characteristics near an inflection region may facilitate controlled luminance attenuation near regions exhibiting elevated crosstalk. In some embodiments, an inflection region may be located at or near a normalized spatial relationship value (D=0.5). Such an arrangement may cause luminance transitions to occur near intermediate portions of viewpoint-image regions.

In some embodiments, locating an inflection region near intermediate spatial locations may balance crosstalk suppression and luminance preservation. For example, pixels located near viewpoint-image boundaries may receive stronger luminance attenuation, while pixels located near central regions may maintain relatively higher luminance values. In various embodiments, the S-shaped function may comprise one or more of: a sigmoid function; a hyperbolic tangent function; an error function; an arctangent function; a generalized logistic function; a Gudermannian function; or combinations thereof.

Such functions may share one or more characteristics including continuous differentiability, monotonic behavior, nonlinear transition characteristics, local slope variation, and one or more inflection regions. Although specific examples of S-shaped functions are disclosed herein, other nonlinear functions exhibiting similar transition characteristics may additionally be employed. In some embodiments, different S-shaped functions may exhibit different local slope distributions while maintaining similar luminance-transition behavior.

In some embodiments, luminance values may be determined using one or more stored mapping structures. For example, a lookup table (LUT) may employ one or more spatial relationships as indices and may store corresponding luminance values, luminance ratios, nonlinear transition parameters, or combinations thereof.

Spatial relationships used for indexing may include distance information, normalized distance values, relative positions, region identifiers, or combinations thereof. During operation, a processor may determine a spatial relationship associated with a display pixel and may retrieve corresponding luminance information from the lookup table. Use of stored mapping structures may reduce computational complexity and may facilitate implementation in high-resolution or high-refresh-rate display systems.

In some embodiments, stored mapping structures need not be limited to lookup tables and may additionally include multidimensional lookup structures, calibration databases, interpolation structures, parameter matrices, trained models, or combinations thereof. In some embodiments, functionality associated with determining luminance values and nonlinear luminance transition behavior may be implemented using hardware circuitry, software modules, firmware modules, or combinations thereof.

Such functionality may be implemented in one or more of: a timing controller (TCON); a graphics processing unit (GPU); display driver integrated circuitry (DDIC); dedicated image-processing circuitry; application-specific integrated circuitry (ASIC); or combinations thereof.

In some embodiments, implementation in dedicated hardware may facilitate real-time luminance adjustment in high-resolution and high-frame-rate applications. In some embodiments, the optical elements may comprise elongated lenticular lenses disposed above the display pixel array. The elongated lenticular lenses may extend substantially parallel to one another and may be disposed at an inclined angle θ relative to a column direction of the display pixel array. The inclined arrangement may facilitate viewpoint-image distribution and may reduce visual artifacts associated with image separation.

In some embodiments, the angle θ may be selected according to optical characteristics, display geometry, viewpoint configuration, or combinations thereof. In other embodiments, the optical elements may comprise liquid-crystal lenses. The liquid-crystal lenses may include a plurality of lens units repeatedly defining pixel groups associated with different viewpoint images. Adjacent pixel groups may be separated by boundaries corresponding to adjacent viewpoint images.

In some embodiments, the liquid-crystal lenses may dynamically alter optical behavior according to display modes, operating conditions, or electrical control signals. In some embodiments, the processor may dynamically update the nonlinear luminance transition function during display operation.

For example, different nonlinear luminance transition functions and/or parameter sets may be selected according to display content, image characteristics, viewing conditions, or operating conditions. Display content may include static images, moving images, text content, graphical content, gaming content, video content, or combinations thereof. Operating conditions may include viewing distance, viewing angle, ambient brightness, display mode, image motion characteristics, thermal conditions, user characteristics, or combinations thereof.

In some embodiments, dynamic updating may involve selection of different function types, control coefficients, slope parameters, local slope characteristics, inflection locations, or combinations thereof. Accordingly, nonlinear luminance behavior may adapt to changing display environments and may provide improved crosstalk suppression while maintaining image quality.

Through implementation in such processing hardware, real-time luminance control of display pixels may be achieved and may support high-resolution and high-refresh-rate display operation. Accordingly, embodiments of the present disclosure may provide practical and scalable techniques for improving image fidelity and viewing experience in autostereoscopic display systems.

Although specific embodiments have been described herein, one of ordinary skill in the art will recognize that various modifications, substitutions, and alternative implementations may be employed without departing from the scope of the present disclosure. Accordingly, the disclosed embodiments should be considered illustrative rather than limiting, and the scope of protection should be determined according to the appended claims and equivalents thereof.

1. A display apparatus, comprising:
a display pixel array configured to generate image content for viewing by a viewer;
an array of optical elements disposed over the display pixel array and configured to direct different viewpoint images toward a left eye and a right eye of the viewer to provide an autostereoscopic effect;
a memory storing computer-executable instructions; and
a processor configured to execute the computer-executable instructions, wherein the processor is configured to:
for a given display pixel, determine a spatial relationship between the given display pixel and a boundary separating adjacent viewpoint images; and
determine a luminance value of the given display pixel according to a nonlinear luminance transition function based on the spatial relationship,
wherein pixels closer to the boundary are assigned lower luminance values than pixels farther from the boundary; and
a local slope of the nonlinear luminance transition function varies according to the spatial relationship so as to reduce crosstalk while maintaining image brightness.

2. The display apparatus of claim 1, wherein the display pixel array is partitioned into a plurality of regions, and the nonlinear luminance transition function or one or more parameters thereof are separately selected or determined for respective regions.

3. The display apparatus of claim 2, wherein the spatial relationship comprises distance information, normalized coordinate information, relative position information, or combinations thereof.

4. The display apparatus of claim 3, wherein the spatial relationship includes a distance ratio D satisfying D=d/Lp, wherein d represents a distance between the given display pixel and the boundary, and Lp represents a pitch of the optical elements.

5. The display apparatus of claim 4, wherein the nonlinear luminance transition function comprises one or more variable slope parameters configured to control luminance transition behavior.

6. The display apparatus of claim 5, wherein the processor is configured to dynamically determine the one or more variable slope parameters according to at least one of: image-content characteristics, viewing distance, image motion information, local image contrast, and viewer information.

7. The display apparatus of claim 6, wherein the nonlinear luminance transition function comprises an S-shaped function.

8. The display apparatus of claim 7, wherein the S-shaped function is continuously differentiable and includes one or more inflection regions.

9. The display apparatus of claim 8, wherein the S-shaped function is selected from a group consisting of: a sigmoid function, a hyperbolic tangent function, an error function, an arctangent function, a generalized logistic function, and a Gudermannian function.

10. The display apparatus of claim 2, wherein the parameters are determined using a lookup table or stored mapping structure indexed according to the spatial relationship.
